(19) United States
(12) Patent Application Publication
(10) Pub. No.: US 2024/0017216 A1
(43) Pub. Date: Jan. 18, 2024

(54) DIRECT LITHIUM EXTRACTION (DLE) PROCESS WITH PRECURSOR HARDNESS TREATMENT AND SUBSEQUENT CONVERSION TO LIOH MONOHYDRATE AND LI2CO3

(71) Applicant: Energy Exploration Technologies, Inc., Austin, TX (US)

(72) Inventors: Amit Patwardhan, Austin, TX (US); Teague Egan, Dorado, PR (US); Angelo Kirchon, Austin, TX (US)

(73) Assignee: Energy Exploration Technologies, Inc., Austin, TX (US)

(21) Appl. No.: 17/802,358

(22) Filed: Aug. 25, 2022

Related U.S. Application Data
(60) Provisional application No. 63/147,656, filed on Feb. 9, 2021.

(51) Int. Cl. B01D 61/44; B01D 61/46; B01D 69/14; B01D 71/02; B01D 11/04; B01D 15/36; B01D 9/00; C01D 15/02

(52) U.S. Cl. CPC B01D 61/445; B01D 61/461; B01D 69/1411; B01D 71/028; B01D 11/0415; C01P 2006/80; B01D 9/0059; C01D 15/02; B01D 2311/06; B01D 2311/04; B01D 15/361

(57) ABSTRACT

A lithium-generating system can include a lithium-containing source feed, a hardness reduction unit, and a bipolar electrodialysis or electrolysis unit. The lithium-containing source feed can provide a lithium-containing material. The hardness reduction unit can be configured to receive the lithium-containing material and reduce the hardness thereof yet still be over 10 ppm upon processing by the hardness reduction unit. The bipolar electrodialysis unit can process the lithium-containing material and generate an aqueous LiOH product. The hardness reduction unit is configured to produce a hardness level within a given hardness-reduced lithium-containing material to be within an upper operational limit of at least one bipolar membrane, in addition to being at a given hardness level of over 10 ppm. The lithium-generating system can further include components to facilitate production of Li₂CO₃ and/or LiOH·H₂O.

### RELATED APPLICATIONS

This application is a Continuation-in-Part of PCT Application No. PCT/US22/15850, filed on Feb. 9, 2022, and entitled “Systems and Methods for Direct Lithium Hydroxide Production,” which claims priority to U.S. Provisional Application No. 63/147,656, filed Feb. 9, 2021, entitled “Systems and Methods for Direct Lithium Hydroxide Production.”

### BACKGROUND

The largest lithium resource and production areas in the world are the lithium bearing brines in South America. Lithium demand pressure has already made the previously uneconomic hard rock lithium resources now viable too, with a significant proportion of new supply coming from these sources, which are predominantly located in Australia. There has also been a shift in the demand projections for lithium precursors, namely lithium carbonate and hydroxide, with future projections favoring the hydroxide.

To produce lithium from any of the above resources, currently a lithium carbonate precursor must be produced followed by its conversion to lithium hydroxide. This presents a large and potentially unnecessary cost when the ultimate goal is lithium hydroxide. This is, however, necessitated as a commercially viable path directly to lithium hydroxide has heretofore not been currently available.

Naturally derived lithium brine concentrate, e.g., pond evaporated brine, contains a large proportion of non-lithium cations such as Na, K, Mg, and Ca. The Na ion, in particular, is pervasive in the lithium extraction process, and lithium bearing brines are virtually always saturated with NaCl together with large amounts of KCl. In several hard rock sources such as jadarite, Na is part of the lithium mineral itself. Caustic leaching of spodumene also introduces a large excess of Na. Even in the more prevalent acid roasting of spodumene, Na content in the leach is typically more than 25% of the lithium content. As the above resource materials are processed, Na₂CO₃ is added to remove Ca and then to finally precipitate lithium carbonate, which also adds more Na to the process.

While purified lithium chloride or sulfate brine can be subjected to membrane electrodialysis to produce relatively clean lithium hydroxide and acid solutions, the pre-membrane purification steps can be costly. Conventional cation selective electrodialysis (ED) membranes are not selective between Li and Na, K, Ca or Mg. As a result, ED on high sodium lithium brines not only results in Na contamination of the LiOH product, but also consumes excessive electricity to transport the unwanted Na⁺ ions along with Li⁺ ions. Even more significantly, the divalent hydroxides are very insoluble and tend to precipitate inside the ED cell making this operation impossible. Based on the current state of the art, before ED can be attempted, extensive reduction of divalent/multivalent ions is necessary and is conventionally attempted via lime addition followed by softening.

However, this still leaves appreciable amounts of Mg depending on the liming pH as well as the amount of Ca in solution. Moreover, monovalent impurities such as Na and K remain in solution with the Na content actually increases due to addition of Na for Ca removal. This approach still faces the same shortcomings even though the precipitation and scaling issues are potentially is reduced. The product is still a mixture of LiOH and NaOH and needs more extensive treatment using multiple fractional crystallizations and ion exchange. Due to the above and related challenges, the only commercially practiced route to LiOH production involves numerous steps and produces an intermediate product, lithium carbonate.

Another emerging approach for lithium brine concentration utilizes mechanical separations and thermal evaporation instead on the solar evaporation and is referred to as Direct Lithium Extraction (DLE). In an embodiment, DLE can include a rough separation of Li from major impurities, such as Na, K, Mg and Ca, using ion exchange, ion sorption and/or solvent extraction. This rough separation can be followed by additional removal of multivalent ions using nanofiltration. Reverse osmosis can then be used to concentrate the brine (Li with the remaining impurities) by separation of water to the point where the pressures required to drive reverse osmosis become impractical. Additional Li and impurity concentration then can follow, using thermal evaporation.

What is needed are more efficient processes for making LiOH from admixtures containing Li, particularly naturally occurring sources such as brine, without necessitating pre-purification of feed brine to the ED or separation membrane and, in particular, without requiring production of the intermediate, lithium carbonate.

Bipolar Electrodialysis or BPED is the combination of electrodialysis for salt separation with electrodialysis water splitting for the conversion of a salt into its corresponding acid and base. The bipolar membranes enhance the splitting of water into protons and hydroxide ions. In conventional BPED lithium (Li) extraction processes, a highly purified lithium brine solution is the feed, which can, for example, be transformed into lithium hydroxide for lithium-ion batteries, manufacture of stearic and/or other fatty acids (e.g., grease thickeners), a carbon dioxide scrubber, a precursor material for other useful lithium compounds (e.g., lithium fluoride, lithium carbonate), and/or an additive for some ceramic and/or Portland cement formulations.

However, the historical issue with commercialization of this technology is that the Li-containing brine solution has needed to be HIGHLY PURIFIED. For example, utilizing a conventional/commercially available Cation Exchange Membrane (CEM) in a BPED process generally allows co-permeation of other cations from the feed stream, along with the desired lithium. The presence of Mg (magnesium) and Ca (calcium) salts can lead to the formation of insoluble hydroxides in the base product, which tend to precipitate in the process and clog/obstruct the CEM. The resulting obstruction can reduce the rate of Li production and eventually block flow of the base product, which can impede productivity/throughput and, ultimately, damage the process equipment and/or shut down the process.

In another aspect, there has been a recent drive to develop systems and/or process that are considered carbon-negative, for example, able to capture carbon dioxide (CO₂) and thereby reduce the amount of CO₂ released into the atmosphere.

### DRAWINGS

The Detailed Description is described with reference to the accompanying figures.

FIG. 1 is a plot of voltage versus time during a constant-current commercial membrane test as part of a conventional BPED (bipolar electrodialysis) procedure.

FIG. 2 is a photographic view of a plurality of commercial membranes before and after use in BPED test using ˜1500 ppm hardness, with representative membranes taken from near the cathode and anode.

FIG. 3 shows (a) a conventional process for LiOH production, (b) a simplified low-cost lithium selective BPED-membrane-based production process for LiOH production, and (c) application of the BPED-membrane-based process of (b) optionally after feed brine liming and softening.

FIG. 4 is atypical direct lithium extraction (DLE) process block flow diagram showing the general steps to mechanically concentrate and separate lithium from impurities instead of using solar evaporation ponds.

FIG. 5 illustrates bipolar membrane electrodialysis of atypical low-sulfate Chilean sourced evaporation pond-concentrated lithium feed brine using (a) a conventional cation over anion selective electrodialysis membrane, (b) a lithium selective cation exchange membrane, and (c) a bipolar membrane electrodialysis using a cation over anion selective membrane after lime-soda softening of feed brine to remove multivalent impurities like Mg and Ca.

FIG. 6 shows bipolar membrane electrodialysis of a typical Argentinian sourced evaporation pond—concentrated lithium feed brine using (a) a conventional cation over anion selective electrodialysis membrane, (b) a lithium selective cation exchange membrane, and (c) cation over anion selective membrane after lime-soda softening of feed brine.

FIG. 7 illustrates bipolar membrane electrodialysis of spodumene sulfuric acid roasted leach using (a) a conventional cation over anion selective electrodialysis membrane, (b) a lithium selective cation exchange membrane, and (c) a cation over anion selective membrane after lime-soda softening.

FIG. 8 is a schematic diagram of a carbon negative and/or carbon neutral lithium BPED-based extraction and product generation process, in accordance with an example embodiment of the present disclosure.

FIG. 9 is a schematic diagram of a simplified low-cost lithium selective BPED membrane-based production process for LiOH production, in accordance with an example embodiment of the present disclosure.

FIG. 10 is a schematic diagram of a bipolar membrane electrodialysis system for processing a feed brine containing unwanted monovalent and divalent cations and divalent anions with a highly Li selective membrane to directly produce a clean LiOH solution.

FIGS. 11A and 11B are schematic diagrams of, respectively, an electrolysis system and a bipolar electrodialysis system for processing a brine carrying a salt (e.g., LiCl or NaCl) of interest, the electrolysis system and/or the bipolar electrodialysis system being usable with an example embodiment of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope.

### INTRODUCTION

Using a suitable membrane lithium selective cation exchange membrane or monovalent cation selective membrane, some or most of the currently used processing steps can be eliminated, resulting in much more efficient lithium hydroxide production from lithium-containing resources such as concentrated feed from direct lithium extraction processes, brine evaporation ponds, or by other means such as rock leachates or steams derived from recycled batteries.

In one embodiment, the present disclosure provides methods for producing a substantially clean LiOH solution directly from admixtures containing Li and one or more impurities, by feeding the admixture to a bipolar membrane electrodialysis or BPMED cell containing a lithium ion selective membrane or monovalent selective cation exchange membrane, and operating these ion selective membranes under a potential difference to obtain a separate LiOH solution, wherein the separate LiOH solution contains from about 1 to 14 wt % LiOH, Mg in the range of about 0 to 3 ppm, and Ca in the range of about 0 to about 5 ppm. Other LiOH concentrations within the separated LiOH solution also are possible. In a preferred embodiment, the ion selective membrane is contained with a BPMED cell. It is to be understood that the acronyms BPED and BPMED may be used interchangeably herein, as both are used to indicate “bipolar electrodialysis” and/or “bipolar membrane electrodialysis.” In an embodiment, it is to be understood that an electrolysis process to yield a Li-containing solution can be employed (instead of one or more bipolar membranes) that can incorporate a lithium-ion selective membrane or monovalent selective cation exchange membrane.

In one case, the admixture contains lithium in amounts of about 1,500 to about 60,000 ppm. In another, the admixture includes impurity ions selected from the group consisting of monovalent and divalent cations and divalent anions. The impurity ions may be selected from the group consisting of Mg, Ca, Na and K ions (e.g., Mg²⁺, Ca²⁺, Na²⁺, or K⁺). In an embodiment, the admixture includes Li ions and at least one of Mg, Ca, Na, or K ions. In an embodiment, the admixture includes at least one of a ratio of Li/Mg ions in a range of about 3 to about 50 or a ratio of Li/Ca ions in a range of about 5 to 20. In one aspect, the admixture includes a ratio of Li/Mg ions in the range of about 3 to about 20. In another aspect, the admixture includes a ratio of Li/Ca ions in the range of about 5 to about 10. In yet another aspect, the admixture contains a ratio of Li/Na and Li/K ions in the range of about 1.5 to about 70. In an embodiment, the admixture is a concentrated lithium brine generated from a process including at least one of pond evaporation, direct lithium extraction, or leaching of lithium minerals using water or acid. The admixture may comprise a rock leachate, such as from spodumene, jadarite, hectorite clays, zinnwaldite, or other lithium bearing minerals. In an embodiment, the admixture may include lithium bearing minerals derived from recycled sources (e.g., recycled batteries).

In an embodiment, the ion selective membrane is at least one of a lithium selective membrane, a monovalent cation selective membrane, or a cation over anion selective membrane. In a preferred embodiment, the ion selective membrane is a lithium selective membrane having a selectivity in the range of 10-100. In another aspect, the lithium selective membrane has a selectivity in the range of Li/Mg, Ca of at least 10 and Li/Na, K of at least 3. In a particularly preferred embodiment, the ion selective membrane is a lithium selective membrane including a polymer matrix and metal organic framework (MOF) particles disbursed therein. In another embodiment, the cation selective membrane is a cation over anion selective membrane, and liming and/or another precursor hardness reducing step(s) can be performed before feeding the admixture to the BPED or electrolysis cell containing the membrane. In an embodiment, the membrane can be a selective cation exchange membrane (sCEM).

As alluded to above with respect to implementation of a liming/hardness reducing step, if the Mg and/or Ca loading of the feed brine is high, a precursor hardness reduction step to reduce the hardness (e.g., total content of Mg and/or Ca) can be performed prior to using electrolysis or bipolar electrodialysis to directly form/generate LiOH. In an embodiment, the precursor hardness reduction step can include at least one of lime-soda softening, a preliminary electrodialysis, solvent extraction, or resin/adsorbent extraction step. In an embodiment, the hardness of the feed brine may be reduced to a level within the operational limits of the bipolar membrane stack. In an embodiment, the operational limit of the bipolar membrane stack may, for example, be in the range of 300 ppm to 10,000 ppm (e.g., 1,500 ppm) hardness in the feed to BPMED. In an embodiment, the hardness of the feed brine (upon performing the one or more hardness reduction steps thereon) may be greater than 10 ppm, greater than 100 ppm, greater than 500 ppm, or greater than 1000 ppm, yet less than the operational limits of the bipolar membrane stack. In an embodiment, the operational limits of the present bipolar membrane stack still can exceed those of the currently commercially available bipolar membrane stack, as hardness levels approaching even as much as 10 ppm can adversely affect the operation of the current commercially available bipolar membrane stack (e.g., cause clogging thereof).

In an embodiment, the decision to implement the precursor hardness reduction step may be determined, for example, based upon knowledge of the brine chemistry to be processed (e.g., information conveyed about the brine upon shipment/provision thereof) and/or by one or more sensors and related controllers associated with the overall system (e.g., in situ measurement used to trigger a hardness reduction, as warranted). That is, in a situation in which the hardness of the initial lithium-carrying feed material (e.g., source brine or other material) is within the operational limits of the electrolysis and/or BPED system employed, the use of the hardness reduction step can be obviated. In a further embodiment, the hardness reduction functionality can be incorporated in the system to allow the system to accommodate a greater range of initial feed brine compositions yet only selectively employed, as when warranted by excessive hardness levels relative to the operational limits of the electrolysis or BPED system.

In an embodiment, the process bypasses or at least significantly mitigates the need for formation of lithium carbonate as a precursor to LiOH. In another aspect, the process is substantially free of lithium carbonate formation as a precursor to LiOH. In another embodiment, partial lithium separation as lithium carbonate, phosphate, oxalate or other precipitates may be produced from the feed brine, and the remaining lithium-containing feed then advances through bipolar electrodialysis or electrolysis to directly produce LiOH. In an embodiment, the resulting lithium hydroxide solution is then crystallized to produce lithium hydroxide monohydrate with a purity in the range of about 95 to 99.9 wt %. In another aspect the lithium hydroxide solution comprises lithium hydroxide in the range of from 1 to 14 wt %.

In an embodiment, an electrolysis unit can be employed instead of a bipolar electrodialysis unit. Three-compartment bipolar electrodialysis and three-compartment electrolyzers (e.g., for performing electrolysis) are both capable of converting a stream of salt into acid and caustic products. the two technologies have in common are the following:
Salt is fed in, converting into their constituent acid and caustic products (e.g., NaCl becomes NaOH and HCl).
Both utilize a cation exchange membrane and an anion exchange membrane to transfer the key salts into the two product streams.
Water is split into H+ and OH− to mix with the anion and cations
Gas is produced at the anodes and electrodes (H₂ at the cathode, and O₂ and potentially Cl₂ at the anode).

The following are ways the two technologies are not the same:
Everywhere BPED uses a bipolar membrane, electrolysis instead employs two solid metal electrodes. Generally, this can mean the capex for electrolysis can be much higher. BPED only requires one anode and one cathode for the entire unit.
Because there are many more electrodes used in electrolysis, there can be much more gas produced (e.g., H₂ and O₂; and, where a chloride is the salt, Cl₂). Commercial-scale electrolysis equipment can be expected to produce a huge amount of gas. Therefore, where it is considered, it is not typically for applications where the main anion is used to process a chloride salt. Most uses of electrolysis have heretofore involved a sulfate salt.
Electrolysis, because of the solid electrodes employed, can facilitate the production of higher concentration solutions with low cross-contamination (e.g., solid electrodes not as prone to cross contamination and/or unwanted osmosis as membranes).

In an embodiment, boron solvent extraction is performed before feeding the admixture to the BPED or electrolysis cell or membrane. In yet another embodiment, the admixture is an evaporated concentrate from a series of brine ponds and the method further comprises membrane separation of Mg and recycle of the separated Mg to previous ponds for precipitation to produce a lower Mg content Li-concentrated feed brine substantially as disclosed in our co-pending patent application Ser. No. 63/023,528, filed May 12, 2020, titled Systems and Methods for Recovering Lithium from Brines, which is hereby incorporated by reference herein in its entirety.

The present disclosure in an example embodiment also provides a system configured to directly produce LiOH substantially without producing a lithium carbonate precursor. The system can include an electrolysis or BPMED cell containing an ion selective membrane; a feed inlet upstream of the membrane and configured to receive an admixture including a concentrated lithium brine from a process selected from the group consisting of pond evaporation, direct lithium extraction, and leaching of lithium minerals using water or acid; and an outlet downstream of the membrane configured to convey a LiOH solution (e.g., as yielded by BPED/BPMED/Electrolysis). The LiOH solution may contain from about 1 to about 14 wt % LiOH, Mg in the range of about 0 to 100 ppm, and Ca in the range of about 0 to about 100 ppm.

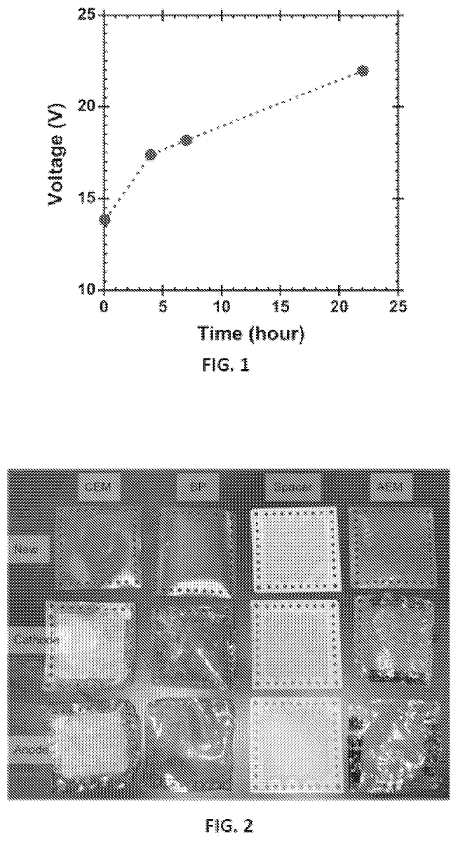

With respect to conventional BPED performed using commercially available membranes, experimentation performed by the present research team has validated the insufficiency of such membranes when tested using brines with ˜1500 ppm (parts per million) hardness, confirming that commercial membranes cannot withstand high hardness levels. Such tests were performed using best-available commercial membranes for BPED. As shown in FIG. 1, there was a continuous increase in voltage during this constant-current commercial membrane test. FIG. 1 particularly illustrates a plot of voltage increase in a 10-triplet membrane stack at a constant current of 1.5 Amps (234 A/m²). The rise in voltage from 13.86 to 21.97 V, as shown in FIG. 1, is due to salt scaling (e.g., Mg(OH)₂ and/or Ca(OH)₂) on the membranes, which subsequently increases their resistance to ion permeation and thus increases the voltage required to maintain a constant current. Considerable amounts of Ca(OH)₂ and Mg(OH)₂ precipitates formed in the base product as the BPED test progressed due to passage of Ca²⁺ and Mg²⁺ through the CEM. After the 22-hour period had concluded, the stack was disassembled, and the membranes were inspected. This post-mortem analysis showed significant wrinkling, swelling, and scaling of the CEM, as shown in FIG. 2.

Responsive thereto, according to an embodiment of the present disclosure, a BPED process has been developed that has been named selective BPED (sBPED). According to an embodiment, the sBPED can employ a selective CEM (sCEM) with coatings that facilitate the selective permeation of monovalent ions much more readily than divalent ions (e.g., Ca²⁺ and Mg²⁺). In an embodiment, the present membrane can result in high Li⁺ selectivity over contaminants, such as Ca²⁺ and/or Mg²⁺. Mg²⁺ is common in brines around the world and can be particularly difficult to separate from Li-brines due to its similarity to Li⁺ in terms of ionic radius and chemical properties, while Ca²⁺ can be found in abundance, for example, in geothermal brines such as the Salton Sea brines, as well as others.

The use of sCEMs in the BPED process can enable simultaneous extraction and purification of Li brines using an enormously simplified process. As such, the sCEMs can be used to avoid the drawbacks of the non-selective BPED process. Further, unlike the conventional route, the present system/process can avoid forming lithium carbonate (Li₂CO₃) as an intermediate product. Instead, the sBPED process can be used to directly produce a high-purity LiOH product, where the purity level may be at least 95% (by weight) or even up to 99.99% (by weight). The use of such sCEMs can likewise prove beneficial when using an electrolysis procedure to generate LiOH or another metal hydroxide from a salt (e.g., LiCl).

In an embodiment, a portion (e.g., about half) of the sBPED base product can be used to synthesize the solid LiOH monohydrate (LiOH·H₂O (s)). This solid phase can be precipitated by an evaporative precipitation process. In an embodiment, for example, 70-90% (e.g., 85%) of the total volume can be evaporatively precipitated and then purified. In an embodiment, the precipitant can be washed with CO₂-free deionized water under a cold CO₂-free environment. The purified precipitant can be fully dried under vacuum and may be further recrystallized in order to obtain an even higher purity.

In an embodiment, a second portion (e.g., the other half) of the sBPED base product can be used for generating an end product of Li₂CO₃ (as opposed to being an unwanted intermediary). This carbonate end product can be formed by bubbling or otherwise delivering a CO₂-containing gas into the LiOH-containing base product. In an embodiment, the bubbling can occur until the solution is able to maintain a sufficiently basic pH to drive lithium carbonate precipitation. In an embodiment, the pH to drive precipitation can be greater than 10 or even greater than 12 (e.g., 12.5). In an embodiment, an indicator of lithium precipitation can be the solution becoming turbid in the process. The solution and precipitated lithium carbonate may further be filtered under vacuum.

In an embodiment, the CO₂-containing gas can be generated from a direct air capture (DAC) system for CO₂ and/or via a flue gas system. Overall, the generation of high purity Li products can be performed from the BPED product and with the use of carbon negative CO₂, a carbon neutral or carbon negative lithium process can be developed.

Using a suitable membrane such as Li selective or monovalent cation selective membranes in BPMED, some or most of the currently used processing steps in the production of LiOH can be eliminated, resulting in much more efficient lithium hydroxide production from lithium-containing resources such as concentrated feed from direct lithium extraction processes, brine evaporation ponds, or by other means such as rock leachates.

The present disclosure provides methods for producing a substantially clean LiOH solution directly from admixtures containing Li and one or more impurities, by feeding the admixture to an electrolysis or BPMED cell containing a lithium ion selective membrane or a monovalent cation selective membrane, and operating such membrane under a potential difference to obtain a separate LiOH solution, wherein the separate LiOH solution contains from about 1 to 14 wt % LiOH, Mg in the range of about 0 to 100 ppm, and Ca in the range of about 0 to about 100 ppm. Other LiOH concentrations within the separated LiOH solution also are possible, and the separated LiOH solution may contain other ions, such as Na and/or K. In an embodiment, the ion selective membrane is contained with a BPMED cell. Such a method and process is discussed in detail in PCT/US22/15850, filed Feb. 9, 2022, the contents of which are hereby incorporated by reference thereto.

In one case the admixture contains lithium in amounts of about 1,500 to about 60,000 ppm. In another, the admixture contains impurity ions selected from the group consisting of monovalent and divalent cations and divalent anions. The impurity ions may be selected from the group consisting of Mg, Ca, Na and K ions. In one aspect, the admixture contains a ratio of Li/Mg ions in the range of about 1 to about 40 or, more specifically, about 3 to about 20. In another aspect, the admixture contains a ratio of Li/Ca ions in the range of about 5 to about 100, about 1 to about 25, or, more specifically, about 5 to about 10. In yet another aspect, the admixture contains a ratio of Li/Na and Li/K ions in the range of about 1 to about 110 or, more specifically, about 1.5 to about 70. In an embodiment, the admixture can be a concentrated lithium brine from a process selected from the group consisting of pond evaporation, direct lithium extraction, and leaching of lithium minerals using water or acid or a concentrated lithium brine from a combination of such processes. In an embodiment, the admixture may comprise a rock leachate, such as from spodumene, jadarite, hectorite clays, zinnwaldite, and/or other lithium-bearing minerals. In an embodiment, the admixture may be derived from a battery recycling waste stream.

In one aspect, the ion selective membrane is selected from the group consisting of a lithium selective membrane, a monovalent cation selective membrane, or a cation over anion selective membrane. In an embodiment, the ion selective membrane can be a lithium selective membrane having a selectivity in the range of 10-100. In an embodiment, the term “selectivity,” in reference to, for example, lithium selectivity, can be defined here as the ratio of Li ions recovered/feed Li concentration, to the ratio of other ion recovered/other ion feed concentration. In an embodiment, the ion selective membrane can be a lithium selective membrane comprising a polymer matrix and metal organic framework (MOF) particles disbursed therein. In another embodiment, the cation selective membrane can be a cation over anion selective membrane and liming and softening is performed before feeding the admixture to the electrolysis or BPMED cell.

In an embodiment, the process can bypass or at least significantly mitigate the need for formation of lithium carbonate as a precursor to LiOH. In another aspect, the process can be substantially free of lithium carbonate formation as a precursor to LiOH. In another embodiment, partial lithium separation as lithium carbonate, phosphate, oxalate or other precipitates may be produced from the feed brine, and the remaining lithium-containing feed then advances through bipolar electrodialysis to directly produce LiOH. The resulting lithium hydroxide solution can then be crystallized to produce lithium hydroxide monohydrate with a purity in the range of about 95 to 99.9 wt %. In another aspect, the lithium hydroxide solution can include lithium hydroxide in the range of from 1 to 14 wt %.

The present disclosure also provides a system configured to directly produce LiOH substantially without producing a lithium carbonate precursor. The system can include an electrolysis or BPMED cell including an ion selective membrane selected from the group consisting of a lithium selective membrane, a monovalent selective membrane, or a cation over anion selective membrane; a feed inlet upstream of the membrane and configured to receive an admixture comprising a concentrated lithium brine from at least one process selected from the group consisting of pond evaporation, direct lithium extraction, and leaching of lithium minerals using water or acid; and an outlet downstream of the membrane configured to convey a LiOH solution containing from about 1 to about 14 wt % LiOH, Mg in the range of about 0 to 100 ppm, and Ca in the range of about 0 to about 100 ppm.

In an embodiment, the system can include a membrane that is a lithium selective membrane. In an embodiment, the membrane can be a selective coated ion exchange membrane (also referred to as a sCEM). In one aspect, the membrane can be a lithium selective membrane comprising a polymer matrix and MOF particles disbursed therein. In another aspect, the lithium selective membrane can have a selectivity in the range of Li/Mg, Ca of at least 10 and Li/Na, K of at least 3.

### EXAMPLE EMBODIMENTS OF THE DISCLOSURE

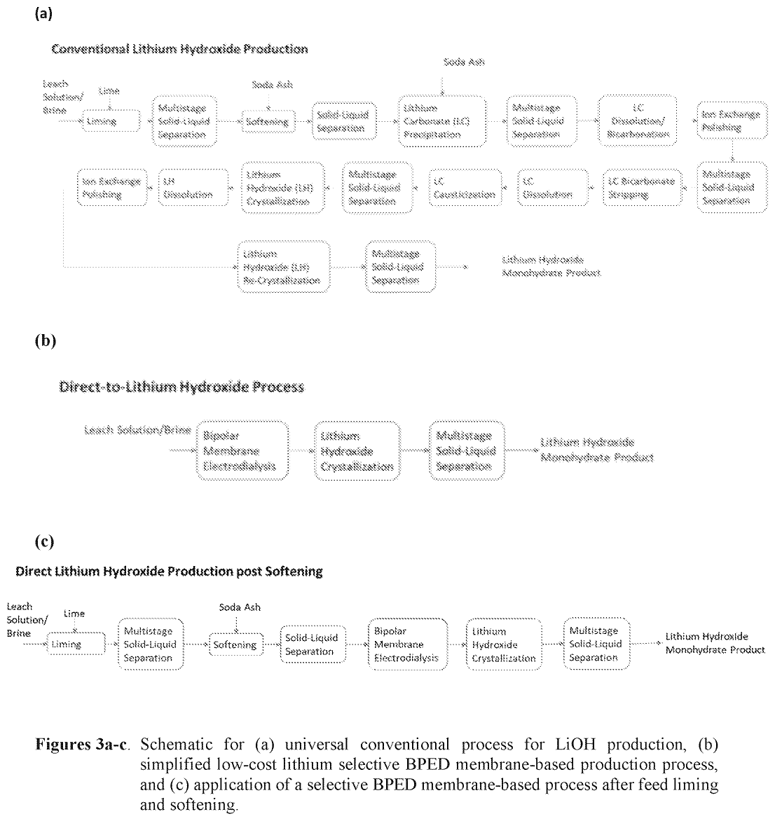

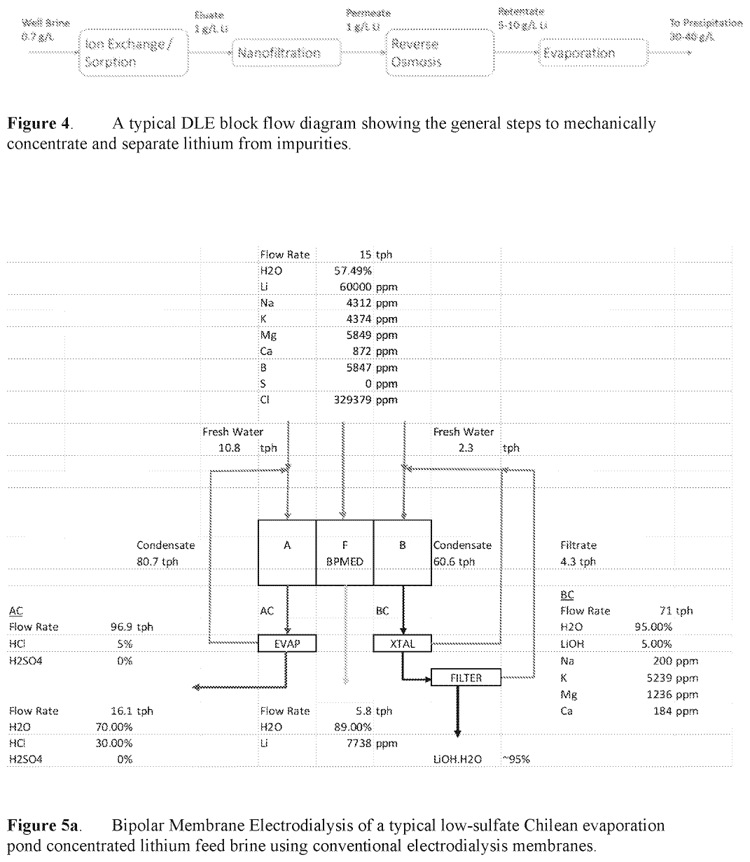

FIG. 3 illustrates (a) a conventional process for LiOH production, (b) a simplified low-cost lithium selective BPED membrane-based production process for LiOH production, and (c) application of the membrane-based process of (b) optionally after feed brine liming and softening. As shown in FIG. 3b, brine or mineral leach solutions (e.g., lithium chloride or sulfate liquor) can be directly subjected to BPMED using a lithium selective or monovalent selective cation exchange membrane (i.e., sCEM). The lithium selective cation exchange membrane largely permits only lithium ions to transfer, producing a high concentration lithium hydroxide solution ready for evaporative crystallization. Thus, application of, for example, a highly Li selective cation exchange membrane as part of a BPED or electrolysis system can provide a pathway to direct LiOH production from less concentrated and impure brines and can eliminate the intermediary Li₂CO₃ processing requirement, and associated capital and operating costs.

If the Mg and/or Ca loading of the feed brine is high, a precursor hardness reduction step/unit to reduce the hardness (e.g., total content of Mg and/or Ca) can be performed prior to using lime soda softening, selective electrodialysis, ion exchange, solvent extraction or other means to directly form/generate LiOH. In an embodiment, the precursor hardness reduction step/unit can include at least one of a lime-soda softening (e.g., water softening), preliminary electrodialysis, solvent extraction, or resin/adsorbent (e.g., a resin-based adsorbent) extraction step/unit. In an embodiment, the hardness reduction unit can have any plumbing/valves, sensor(s), controller, etc., (not shown) associated therewith, as needed, to facilitate the successful operation thereof. In an embodiment, as shown in FIG. 1c, if the Mg and/or Ca loading of the feed brine is high, one or more precursor hardness reduction steps (such as lime-soda softening, per the illustration) may optionally be performed before using a bipolar-electrodialysis-based process to directly generate LiOH, again bypassing intermediary Li₂CO₃ processing requirements. Significant capital and operating cost savings can still be retained in this process.

In an embodiment, the hardness of the feed brine can first be reduced to a level within the operational limits of the bipolar membrane stack. In an embodiment, the hardness of the feed brine (upon performing the one or more hardness reduction steps thereon) may be greater than 10 ppm, greater than 100 ppm, greater than 500 ppm, or greater than 1000 ppm, yet less than the operational limits of the bipolar membrane stack. The operational limits of the bipolar membrane stack can be based in part, for example, on a capability of the membrane stack to retard the transmission of Mg and/or Ca ions therethrough. In an embodiment, the operational limits of the present bipolar membrane stack may be in the hardness range of 300 ppm to 10,000 ppm (e.g., 1,500 ppm).

In an embodiment, by “direct” or “directly” herein with reference to LiOH production, we can mean systems and processes which are capable of substantially bypassing production of the intermediate lithium carbonate precursor to LiOH and, in most cases, also bypassing pre-polishing of, for example, naturally occurring brine, Li-containing rock leachate, or feed from DLE processes. Advantageously, we have found that the methods and systems taught herein substantially reduce the number of processing steps to yield highly concentrated LiOH from Li-containing feed stock that includes naturally occurring and/or other impurities. The resulting LiOH solutions can readily be crystallized by, e.g., evaporation to yield substantially pure (for example 95 to 99.9% pure) lithium hydroxide monohydrate.

As used herein, the term “cation selective electrodialysis membranes” or “cation exchange membranes” or “cation over anion selective membranes” can refer to membranes that are selective between cations and anions, but are not selective between cations such as Li and Na, K, Ca or Mg. Therefore, in the presence of non-lithium impurity cations, such membranes pass the impurity cations along with lithium to yield a mixed hydroxide. “Monovalent selective membranes” or “monovalent selective cation exchange membranes” can mean membranes that are selective between monovalent and divalent ions, and thus permit monovalent ions such as Na⁺, K⁺, and Li⁺ while retarding divalent/multivalent cations, like Ca²⁺ or Mg²⁺. “Monovalent selective membranes” can also be monovalent selective anion exchange membranes that permit passage of essentially only monovalent anions like Cl⁻ or F⁻ while retarding divalent anions like SO₄²⁻. “Conventional electrodialysis membranes” can mean membranes that discriminate between cations and anions and are essentially non-selective between monovalent and divalent ions.

In an embodiment, “electrodialysis” can mean using one or more ion exchange membranes to separate ions from a feed stream into different ion streams under an applied electric potential difference. Any suitable electric potential difference can be used, for example, but not limited to, electrical current in the range of 400 to about 3000 A/m². “Bipolar membrane electrodialysis” or BPMED can mean an electrodialysis process or system, wherein anions and cations are selectively transported across semi-permeable membranes under an electric potential to drive the ions and achieving their separation from a carrier such as water. Bipolar membranes typically comprise cationic and anionic exchange membranes sandwiched together with a hydrophilic interface at their junction. Under an applied current, water molecules migrating to the hydrophilic junction are split into H⁺ and OH⁻ ions, which migrate to produce acids and bases with other anions and cations. Various other BPMED setups are possible using the teachings herein.

The feed compositions herein may contain impurity ion ratios of Li/Mg greater than 3, greater than 5, or greater than 10; and Li/Ca ratios greater than 1.5, greater than 3.5, or greater than 5. The feed lithium content can be greater than 1,000 ppm, greater than 5,000 ppm, or greater than 10,000 ppm. For example, the feed used herein may have compositions containing unwanted impurity ions (such as monovalent and divalent cations and divalent anions) with impurity ion ratios of Li/Mg from 3 to 35, from 3 to 20, or from 5 to 15; and Li/Ca ratios from 5 to 150, from 5 to 100, or from 20 to 50; and Li/Na, K ratios from 1.5 to 15, from 1.5 to 10, or from 3.5 to 7.5; and a feed lithium content typically from 1000 to 60,000 ppm, from 5000 ppm to 25,000 ppm and, in the case of pond evaporated brines, from 10,000 to 60,000 ppm.

Resulting LiOH solutions from the methods and systems disclosed herein can typically include highly concentrated LiOH. For example, LiOH concentration ranges of about 1 to 14% by weight LiOH can be achieved via the present system. In some embodiments, the LiOH concentration is at least 2%. Other concentrations are also possible. Advantageously, these concentrations can readily be crystallized to yield substantially pure lithium hydroxide monohydrate.

With respect to FIGS. 3b and 3c, the present disclosure provides selective bipolar membrane electrodialysis to render most of the state-of-the-art process steps (as shown in FIG. 3a) and intermediary lithium carbonate precipitation unnecessary. We have found that the required membrane Li/Mg, Ca selectivity can be a function of the feed Li/Mg and Li/Ca ratios. For Li/Mg and Li/Ca ratios greater than 10 as is typical for Chilean concentrated brines, a Li/Mg, Ca selectivity greater than 10 can be preferred, and, more preferably, the Li/Mg, Ca selectivity is greater than 30 or greater than 50. For feed Li/Mg ratios less than 10, as may be the case for some Argentinian brines, Li/Mg selectivity greater than 75 can be preferred. Around a feed Li/Mg ratio of 2-5, the approach represented in FIG. 3c can optionally be used and can involve chemical precipitation of Mg before performing direct bipolar electrodialysis to LiOH. In this case, the preferred Li/Mg selectivity may be approximately 10 or greater, and preferably greater than 30. In some embodiments, a higher Li/Na, K selectivity exceeding 10 can be beneficial but not required and can be especially beneficial for the approach shown in FIG. 3c.

Given the teachings herein, suitable selectivities may be chosen based on the feed impurity contents, such that a membrane of a stated selectivity directly yields a non-precipitating LiOH solution, preferably with maximum Mg and Ca contents of less than or equal to about 3 ppm and about 5 ppm, respectively. These Ca and Mg numbers are higher than what can be calculated using the solubility products of Kₛₚ(Mg(OH₂))=5.61E-12 and Kₛₚ(Ca(OH₂))=5.02E-6 (Lide, 2004). However, as known from other prior studies, higher concentrations of Ca and Mg up to 4 mg/L and 0.55 mg/L in the feed have been reported during a long pilot run producing LiOH using bipolar electrodialysis from an ultra-purified brine. Without wishing to be bound by theory, the higher levels of Ca and/or Mg compared to those calculated from solubility products may indicate some stabilizing mechanism that allows them to remain in solution, probably due to the activities of components and stabilizing influence of other impurity ions. We have experimentally verified that up to 5 mg/L of both Ca and Mg can remain in solution in a 5% LiOH solution.

It should be understood that membranes useful in embodiments of the present disclosure can include any membrane which can achieve separation of at least a portion of monovalent ions or lithium from one or more impurities, and preferably targeted monovalent-monovalent and/or monovalent-multivalent separations. As an example, one particularly suitable membrane is a lithium selective cation exchange membrane or monovalent cation selective membrane. Such membranes have been shown to possess monovalent-divalent ion selectivity up to and greater than 500, utilizing metal organic frameworks (MOFs) components. Such membranes also have previously been shown by other researchers to have demonstrated a corresponding Li—Mg selectivity of 1500. Lithium selective cation exchange membranes or monovalent cation selective membranes can also be provided incorporating Li—Na selective MOFs which have demonstrated selectivities of around 1000. Membranes for use herein can also be monovalent selective cation exchange membranes with sufficiently high lithium/divalent selectivity depending on feed brine Mg content and the type of application (FIG. 3b or 3c). Another example is a membrane containing ionophores, which are materials that transport specific ions across semi-permeable surfaces or membranes.

Membranes, such as those described above applied in a BPMED setup, can be used as part of a bipolar electrodialysis cell that is set up into three compartments, in addition to the electrode rinse channels adjacent to the end electrodes. The three-compartment unit containing a cation exchange membrane, bipolar membrane, and an anion exchange membrane can be set up as repeating units. Any number of repeating units can be provided in the electrolysis or BPMED cells contemplated herein. The cation exchange membrane in this example is a Li-selective membrane allowing essentially only lithium ions and water along with minor amounts of impurities to permeate. These membranes can also be monovalent selective, which permit monovalent ions, such as Na, K, and/or Li, while retarding divalent/multivalent cations, like Ca and/or Mg. The bipolar membrane can be a sandwiched cation and anion exchange membrane as described above. The positively charged anion exchange membrane substantially permits only the negatively charged anions to pass, repulsing the positively charged cations. These membranes may also be monovalent selective, permitting essentially only monovalent anions like chloride to permeate relative to the divalent anions such as sulfate.

The feed can enter the central compartment in each repeating unit. With a Li-selective membrane, substantially only Li permeates through the membrane into the adjacent base recovery compartment. Similarly, anions permeate through the anion exchange membrane to the acid recovery compartment. The bipolar membranes on the other side of the compartments provide either H ion to the acid recovery compartment or OH⁻ ions to the base recovery compartment. In this fashion, a clean LiOH stream can be produced directly from the feed brine or leach solution.

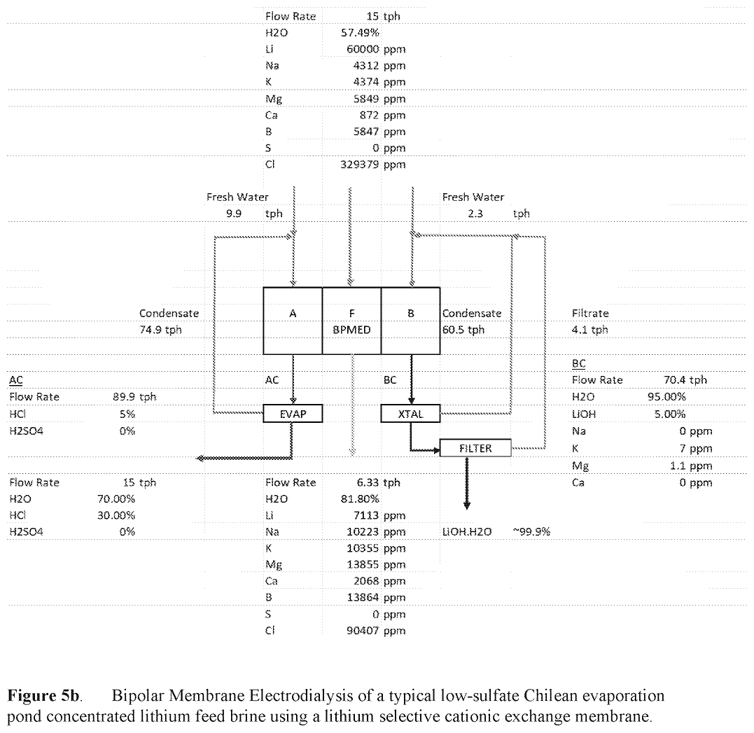

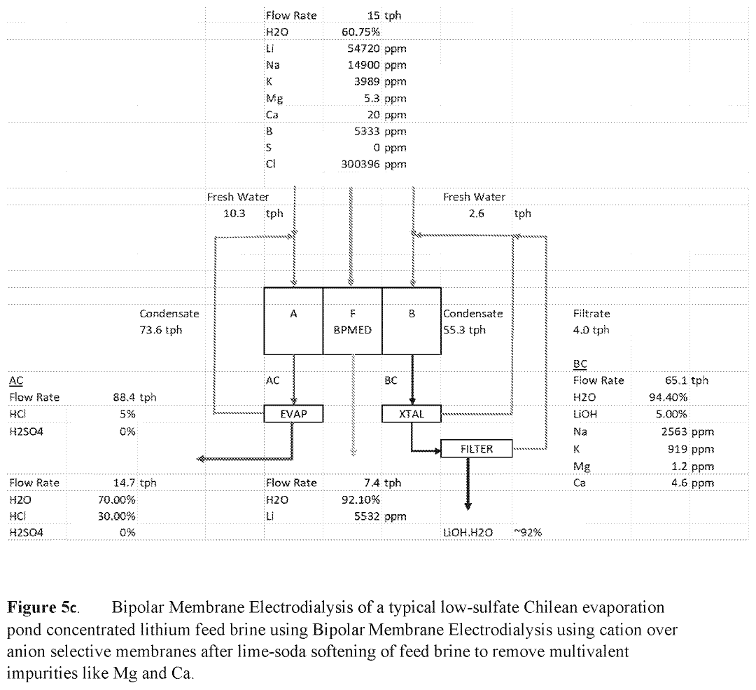

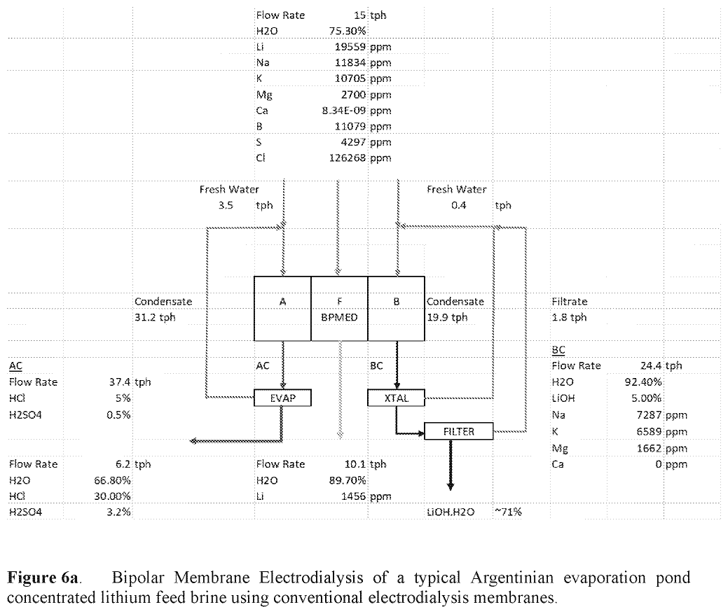

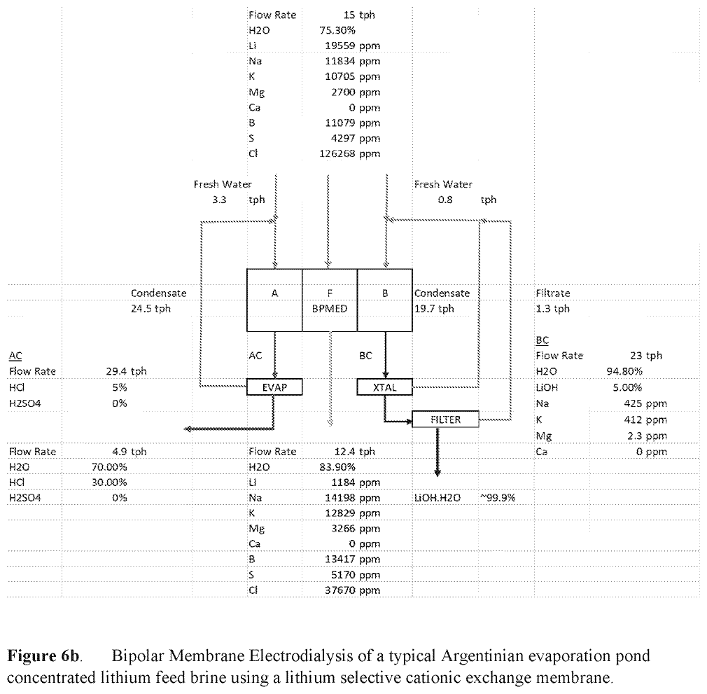

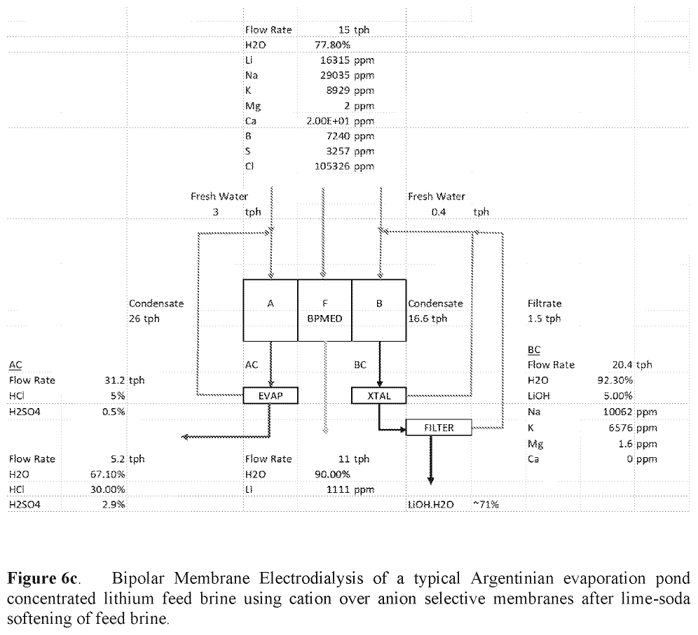

In an embodiment (FIG. 3c), BPMED can be applied after a precursor hardness-reduction step (e.g., a liming and/or soda-liming softening; preliminary electrodialysis; solvent extraction; and/or resin/adsorption extraction step(s)) when the feed brine includes excessively high amounts of multivalent ions (for example, Li/Mg and Li/Ca ratios greater than 5 and greater than 2, respectively; or generally in excess of the operational limits of the bipolar membrane stack). The liming and softening steps, however, can increase the sodium content of the feed brine by replacing the Mg ions with Ca and the Ca ions with Na. In this case, a lithium-selective membrane discriminating between Li and Na can be preferred. However, a cation over anion selective membrane, which only discriminate between cations and anions, may also be used in some cases for a viable process, mainly after softening and/or another hardness-reduction procedure (as discussed elsewhere in the present application), to produce a viable product (FIGS. 5c and 6c). In some cases, conventional ED membranes remain unviable, as shown by the high Ca levels resulting in the catholyte (stream BC in the Figures) containing high Ca levels, which tend to precipitate in the ED cell. Even when the conventional ED membranes give a potentially viable product, in most cases like in FIG. 6c, the product can be of relatively low quality, requiring additional processing steps similar to the steps shown in FIG. 3a, i.e., LiOH recrystallization and ion exchange (IX) to remove Na, K, and/or other trace impurities.

We have surprisingly found that it is possible via the use of suitably selective membranes in electrolysis and/or BPED to reduce or eliminate most of the processing steps required in the conventional LiOH production. Based upon the teachings and illustrative embodiments herein, other embodiments rearranging the process steps or including additional steps can be optional to a person of ordinary skill in the art. For example, other embodiments may include at least one of solvent extraction (SX) of boron from the feed brine or ionic extraction (IX) for boron removal from the feed brine or during LiOH crystallization.

FIG. 8 illustrates a carbon-negative lithium-generating system 100 and related process for generating battery-grade lithium carbonate and lithium hydroxide monohydrate via bipolar electrodialysis, according to an example embodiment of the present disclosure. The lithium-generating system 100 can include an initial CO₂ source 102 (e.g., air, flue gas, etc.); a carbon dioxide capture device 104 (e.g., a device configured to yield an output gas with a higher CO₂ concentration than that of the source 102); and a concentrated CO₂-level (i.e., concentrated relative to a precursor gas) gas output 106, in a first portion of the overall system 100. The lithium-generating system 100 can further include a lithium-containing source feed 108 (e.g., a lithium-containing brine); a bipolar electrodialysis system 110; and a LiOH aqueous product output 112, in a second portion of the overall system 100. The lithium-generating can additionally include a first reaction site/chamber 114 (e.g., configured to facilitate Li₂CO₃ production from LiOH aqueous product and captured CO₂); a battery-grade Li₂CO₃ output 116; a second reaction site/chamber 118 (e.g., configured to facilitate LiOH·H₂O via evaporative crystallization); and a battery-grade LiOH-based output 120, in a third part of the system 100. In an embodiment, the first reaction site/chamber 114 and/or the second reaction site/chamber 118 can respectively include a reaction vessel. In an embodiment, such a reaction vessel can be made of a corrosion-resistant material (e.g., stainless steel, ceramic, etc.) or define at least a corrosion-resistant interior. The system 100 can further include any conduits, valves, flow sensors, controllers, etc., (not shown or at least not labeled) needed to facilitate the operation thereof. It is to be understood that at least one precursor hardness reduction step/component (as discussed elsewhere) can be incorporated as part of the system 100 to provide an appropriate lithium-containing source feed 108 (e.g., a lithium-containing brine) to the bipolar electrodialysis system 110.

In an embodiment, the initial CO₂ source 102 can be, for example, air and/or flue gas, and the carbon dioxide capture device 104 can be any device or system configured to increase the CO₂ concentration than that of the source 102. For example, the carbon dioxide capture device 104 can be a direct air capture device that may increase the carbon dioxide concentration from that typically found in air (e.g., less than 0.1% by volume, less than 0.05% by volume, or about 0.04% by volume) by factor of at least 50 or more (e.g., increasing it to 2% or more by volume; or 5-100% by volume; or 30% or more by volume). Such direct air capture devices are known in the art, and any such unit providing a sufficient volume percentage of CO₂ as part of its concentrated CO₂ gas output 106 to generate a sufficient reaction throughput of lithium carbonate may be employed. With respect to the use of flue gas usage, in an embodiment, the carbon dioxide capture device 104 may be used to reduce the presence of any unwanted gases (e.g., sulfur dioxide, oxides of nitrogen, etc., for example, capturing and/or diverting such gases) that may otherwise interfere with producing high-purity lithium carbonate and, in that process, increase the volume fraction of carbon dioxide therein.

In an embodiment, the carbon dioxide capture unit 104 may be instead considered to be configured to receive a first carbon dioxide containing gas and to output a release gas to be used as the source gas 102 of the carbon dioxide containing gas for use at the first reaction site 114. In an embodiment, the release gas can include a second concentration of carbon dioxide greater than the first concentration of carbon dioxide, the second concentration of carbon dioxide configured to be achieved by a carbon capture process. That is, the sequential order/placement of the source gas 102 and the carbon dioxide capture unit 104 within the lithium-generating system 100 can effectively be switched (e.g., even as a matter of semantics) and still be within the scope of the present disclosure.

In an embodiment, the lithium-generating system 100 can direct a lithium-containing source feed 108 into a bipolar electrodialysis system 110, thereby yielding the LiOH aqueous product output 112. The lithium-containing source feed 108 can be a naturally-occurring lithium-containing brine, a partially processed lithium-containing brine, or another lithium-carrying solution (e.g., a by-product of a chemical process; a recycled brine solution; a lithium solution undergoing further purification; etc.). In an embodiment, the lithium-containing brine may be previously unconcentrated (e.g., pumped from a natural or other original source) or may have been partially concentrated (e.g., subject to one or more treatments and/or evaporation stages).

Per an example test, a synthetic Salton Sea brine was created with the following composition: 15,000 ppm Li, 1,500 ppm Ca, 500 ppm B, and 100 ppm Mg. The brine was treated with bipolar electrodialysis (BPED), utilizing Li-selective cation exchange membranes, in accordance with the present system. After 23 hours of batch testing run time, the final base product contained 6.86% LiOH (aq) with 24 ppm Ca, 67 ppm B, and nondetectable amounts of Mg.

Ion Selectivity Cumulative

| Time | Li/Ca | Li/Na | Li/K | Li/B |
|---|---|---|---|---|
| 0 | | | | |
| 4 | 245.8 | 5.1 | −7.0 | 1966.0 |
| 20 | 936.3 | 5.1 | 14.0 | 295.7 |
| 23 | 1011.7 | 5.3 | 17.0 | 256.7 |

The current sCEM yield high selectivity of lithium over other ions. The Ca selectivity can be extremely high, and the Mg selectivity can be almost infinite.

The details of at least one embodiment of a given bipolar electrodialysis system 110 for yielding the LiOH aqueous product output 112 will be discussed in greater detail later in the application.

In an embodiment, at least a first portion of the LiOH aqueous product output 112, along with the concentrated CO₂ gas output 106, can be used toward generating lithium carbonate at the first reaction site/chamber 114. In an embodiment, any desired portion (e.g., 50%, 50-100%, 25%, etc., by volume of the available total) of the LiOH aqueous product output 112 can be used toward battery-grade lithium carbonate production. In an embodiment, the concentrated-level CO₂ gas (e.g., captured CO₂-carrying gas) can be bubbled/injected through the LiOH aqueous product in the first reaction site/chamber 114 to thereby yield a battery-grade lithium carbonate. The bubbling can be performed until a sufficiently basic pH to facilitate precipitation is reached. In an embodiment, the bubbling of the CO₂-containing gas (e.g., capture release gas) can be performed at room/ambient temperature (e.g., reaction between LiOH and CO₂ is exothermic). For example, at a pH in excess of 10 (e.g., a pH of 12.5), the solution can become turbid and drive precipitation of lithium carbonate therefrom. In an embodiment, the product and/or solution upon bubbling can be filtered under a vacuum and the precipitant fully dried.

In an embodiment, the carbon dioxide in the captured CO₂-carrying gas may be pulled out a power plant (e.g., a flue gas) or directly out of air (e.g., via direct air capture). In an embodiment, the act of using CO₂ from the environment to produce lithium carbonate from a BPED LiOH product can be considered to be a carbon negative process. In an embodiment, the system 100 can yield, for example, the following precipitants and related purity levels:

Purity of BPED precipitated products

| Product Type | Purity (%) |
|---|---|
| LiOH•H₂O (s) | 96.2 |
| Li₂CO₃ (s) | 99.7 |

In an embodiment, a second portion (e.g., less than 100%, 40-60%, 50%, 25-75%, etc., by volume of the available total) of the LiOH aqueous product output 112 can be routed to the second reaction site/chamber 118. At the second reaction site/chamber 118, lithium hydroxide monohydrate can be formed, such as by evaporative precipitation, and outputted in a battery-grade form and/or purity. In an embodiment, at the second reaction site/chamber 118, 85% (by total volume) of the LiOH aqueous product may be evaporated. The precipitated product can be purified by washing with cold CO₂-free deionized water under a cold CO₂-free environment. The purified precipitant can then be fully dried under vacuum. This product can be further recrystallized in order to obtain yet a higher purity.

As shown in FIG. 9, brine or mineral leach solutions (e.g., lithium chloride or sulfate liquor) can be directly subjected to a bipolar electrodialysis using a lithium selective cationic membrane. The lithium selective cationic membrane largely permits only lithium ions to transfer, producing a high concentration lithium hydroxide solution ready for evaporative crystallization. Thus, application of, for example, a highly Li/Na selective bipolar membrane system or, by extension, an electrolysis system can provide a pathway to direct LiOH production from less concentrated and impure brines, and can eliminate the intermediary Li₂CO₃ processing requirement, and associated capital and operating costs. If the Mg, Ca loading of the feed brine is high, at least one of a lime-soda softening and/or another precursor hardness reducing step may optionally be performed before bipolar electrodialysis directly to LiOH, again bypassing intermediary Li₂CO₃ processing requirements. Significant capital and operating cost savings can still be retained in this process.

With respect to the present disclosure, it has been found that the required membrane Li/Mg, Ca selectivity can be a function of the feed Li/Mg and Li/Ca ratios. For Li/Mg and Li/Ca ratios greater than 10, as is typical for Chilean concentrated brines, a Li/Mg, Ca selectivity greater than 10 can be preferred, and more preferably the Li/Mg, Ca selectivity is greater than 30, or greater than 50. For feed Li/Mg ratios less than 10, as may be the case for some Argentinian brines, Li/Mg selectivity greater than 75 can be preferred. Around a feed Li/Mg ratio of 2-5, an approach may be optionally used that involves chemical precipitation of Mg before performing direct bipolar electrodialysis to LiOH. In this case, the Li/Mg selectivity may be approximately 10 or greater, and preferably greater than 30. In all cases, a higher Li/Na, K selectivity exceeding 10 can be beneficial but not required, and can be especially beneficial for the approach in which Mg is first chemically precipitated. Suitable selectivities may be chosen based on the feed impurity contents, such that a membrane of a stated selectivity directly yields a non-precipitating LiOH solution, preferably with maximum Mg and Ca contents of less than or equal to about 3 ppm and about 5 ppm, respectively. These Ca and Mg numbers can be higher than what can be calculated using the solubility products of Kₛₚ(Mg(OH₂))=5.61E-12 and Kₛₚ(Ca(OH₂))=5.02E-6 (as known in the art).

It should be understood that membranes useful in embodiments of the present disclosure can include any membrane which can achieve separation of at least a portion of monovalent ions or lithium from one or more impurities, and preferably targeted monovalent-monovalent and/or monovalent-multivalent separations.

As an example, one particularly suitable membrane can be a lithium selective cation exchange membrane or monovalent cation selective membrane. Such membranes have been shown to possess monovalent-divalent ion selectivity up to and greater than 500 utilizing metal organic frameworks (MOFs) components. Such membranes also have demonstrated a corresponding Li—Mg selectivity of 1500 (as discussed in the art). Lithium selective cation exchange membranes or monovalent cation selective membranes can also be provided incorporating Li—Na selective MOFs which have demonstrated selectivities of around 1000.

In an embodiment, lithium selective cation exchange membrane or monovalent cation selective membrane technology can be a mechanism for lithium-ion transport and/or separation, such as achieved using a metal organic framework (MOF) nanoparticles in a polymer carrier. MOFs have exceptionally high internal surface area and adjustable apertures that achieve separation and transport of ions while only allowing certain ions to pass through. These MOF nanoparticles are materialized like a powder, but when combined with polymer the combined MOF and polymer can create a mixed matrix membrane embedded with the nanoparticles. The MOF particles create a percolation network, or channels, that allow selected ions to pass through. When extracting lithium, the membrane can be placed in a module housing. A feed stream, such as evaporated brine, can pumped through the system with one or more layers of membranes that conduct effective separation, even at high salinities. Membranes for use herein can also be monovalent selective cation exchange membranes with sufficiently high lithium/divalent selectivity depending on feed brine Mg content and the type of application (e.g., FIG. 3b or 3c). For example, the prior art refers to monovalent selective membranes for Li—Mg separation from high Mg content brines achieving high Li recovery and a good selectivity of 20-33.

Another example is a membrane containing ionophores, which are materials that transport specific ions across semi-permeable surfaces or membranes as discussed in the art. Such ionophores are based on 14-crown-4 crown ether derivatives. Other potential examples are supported liquid membranes or ionic liquid membranes in electrodialysis, as described in a review article by Li et al., 2019 where cation selective membranes (with Li—Mg selectivity between 8-33, Li—Ca selectivity around 7, Li—Na selectivity around 3, and Li—K selectivity around 5) are described.

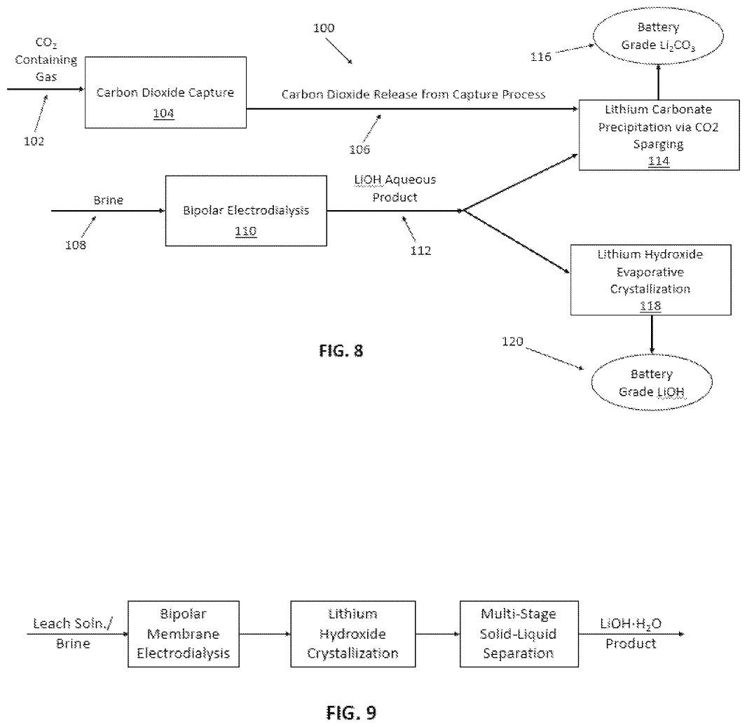

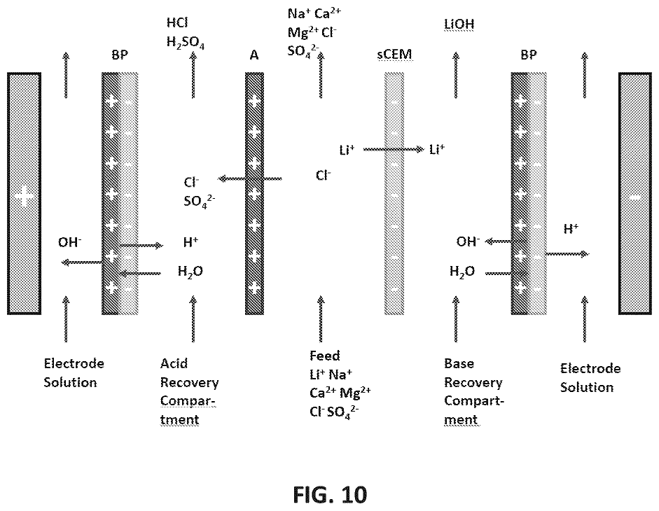

Referring now to FIG. 10, lithium selective cation exchange membranes or monovalent cation selective membranes applied in a BPMED setup are shown. In an embodiment, FIG. 10 can be considered as illustrating a system of bipolar membrane electrodialysis of feed brine (e.g., containing unwanted monovalent and/or divalent cations; and/or divalent anions) using highly Li selective membranes, to produce clean LiOH solutions. In this setup, the bipolar membrane electrodialysis cell can be arranged into three compartments in addition to the electrode rinse channels adjacent to the end electrodes. The three-compartment unit containing a cation exchange membrane (e.g., sCEM), bipolar membrane BP, and an anion exchange membrane A can be configured as repeating units, along with a cathode and an anode associated with the one or more repeating units. Any number of repeating units in the electrolysis or BPMED cells is contemplated hereby. The cation exchange membrane in this example is a Li-selective membrane (e.g., an sCEM), allowing essentially only lithium ions and water along with minor amounts of impurities to permeate. These membranes can also be monovalent selective, which permit passage of monovalent ions, such as Na, K and Li, while retarding divalent/multivalent cations, like Ca or Mg. The bipolar membrane can be a sandwiched cation and anion exchange membrane, as described above. The positively charged anion exchange membrane substantially permits only the negatively charged anions to pass, repulsing the positively charged cations. These membranes may also be monovalent selective, permitting essentially only monovalent anions like chloride to permeate relative to the divalent anions such as sulfate.

The feed can enter the central compartment in each repeating unit. With a Li-selective membrane, substantially only Li permeates through the membrane into the adjacent base recovery compartment. Similarly, anions can permeate through the anion exchange membrane to the acid recovery compartment. The bipolar membranes on the other side of the compartments can provide either H+ ion to the acid recovery compartment or OH− ions to the base recovery compartment. In this fashion, a clean LiOH stream can be produced directly from the feed brine and/or leach solution.

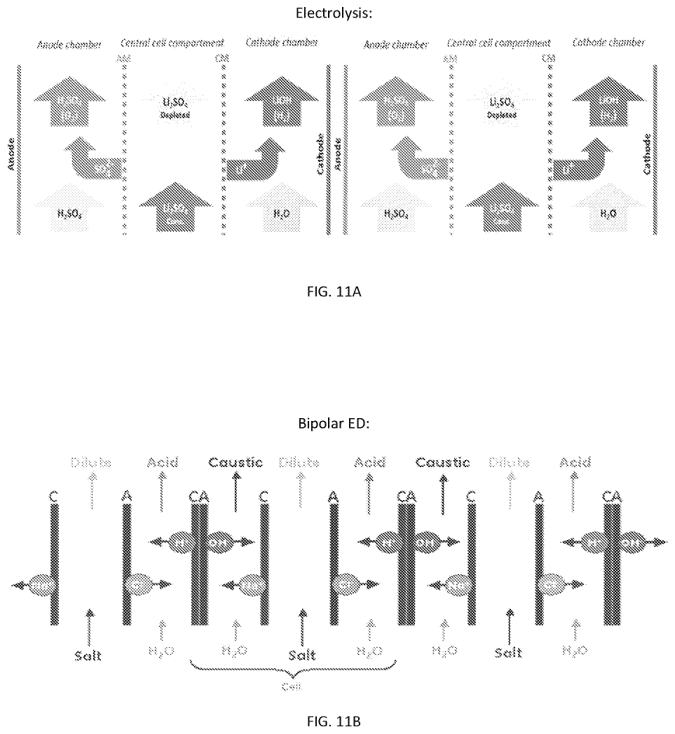

FIGS. 11A and 11B graphically illustrate, respectively, an electrolysis process and a bipolar ED process for separating a salt (e.g., LiCl or Li₂SO₄) to generate a metal hydroxide (e.g., LiOH or NaOH, per the illustrated examples). Per the illustrated example of FIG. 11A, the electrolysis system (also known as an electrolyzer) includes a pair of electrolysis cells but any number of such cells may be employed. A given electrolysis cell can include an anode, a cathode, an anion membrane AM, and a cation membrane CM. The anion membrane AM and the cation membrane CM can together define a central cell compartment for receiving a concentrated salt brine (e.g., concentrated with Li₂SO₄), with a depleted brine (e.g., Li₂SO₄-depleted) exiting therefrom. An anode of a given electrolysis cell and the related anion membrane AM can define an anode chamber, receiving, for example, SO₄²⁻ through the anion membrane AM and yielding H₂SO4 and O₂. A cathode of a given electrolysis cell and a corresponding cation membrane CM can define a cathode chamber, receiving, for example, Li⁺ through the cation membrane CM and yielding LiOH and H₂. It is to be understood that the various outputs (e.g., acid, base, dilute) from each of the chambers can depend on the input salt(s) implemented. In an embodiment, when processing a lithium-based salt, an electrolysis process can be configured to generate an aqueous lithium hydroxide product including lithium hydroxide.

Per the illustrated example of bipolar ED of FIG. 11B, a given bipolar ED can include a number of bipolar electrodialysis (BPED) cells (as shown) and an anode and cathode pair (not shown, but positioned at a respective distal end of the cell stack/grouping). (It is noted that FIGS. 10 and 11B each illustrate an example BPED system, with FIG. 10 drawn more specifically to lithium hydroxide production with FIG. 11B is provided as a comparative aid relative to the electrolysis system of FIG. 11A.) A given BPED cell can include a cation membrane C, an anion membrane A, and a pair of bipolar membranes CA. It is to be understood that each given bipolar membrane CA can be shared with an adjacent cell. In an embodiment, a salt (e.g., as part of a brine, in this case carrying NaCl) can be introduced between a cation membrane C and an anion membrane A associated with a given BPED cell, yielding a dilute output upon action by the related membranes C, A. A facing pair of a bipolar membrane CA and a cation membrane C can respectively yield a hydroxide (OH⁻) ion and a metal ion (e.g., Na⁺, per the illustration), combining to form a caustic/base (e.g., NaOH, per the illustration). A facing pair of an anion membrane A and a bipolar membrane CA can yield a non-metal ion (e.g., Cl⁻, per the illustration) and a hydrogen (H⁺) ion, combining to form an acid (e.g., HCl, per the illustration). It is to be understood that the respective acid and base/caustic to be formed using a given BPED cell can depend upon the input salt processed thereby.

As seen from the from FIGS. 11A and 11B, a given electrolysis cell and a given BPED cell can define a three-compartment arrangement. Both cell types are capable of converting a stream of salt (e.g., salt brine) into acid and caustic products. Both cell arrangements can utilize a cation exchange membrane and an anion exchange membrane to transfer the key salts into the two product streams, with water split into H⁺ and OH⁻ to mix with the anion and cations, yielding the respective acid and base product streams. Finally, each system can yield at least a pair of gases at the anodes and electrodes (H₂ at the cathode; and O₂ and potentially Cl₂ at the anode).

### EXAMPLES

Multiple real-life brine examples from different geographies and sources are provided in the following paragraphs that demonstrate the applicability of the systems and methods described herein in a wide variety of cases. Based on realistic brine chemistries, electrodialysis separation was modeled with and without lithium selective membranes.

For the lithium selective membranes, a Li—Mg, Ca selectivity of 100 was used based on the documented performance of a lithium selective cation exchange membrane or monovalent cation selective membrane. A Li—Na, K selectivity of 50 was used for this selective membrane. Conventional ED modeling has no selectivity between cations. Selectivity is defined here as the ratio of Li ions recovered/feed Li concentration, to the ratio of other cation recovered/other cation feed concentration. Lithium hydroxide concentration in all cases was set at 5%, which is near the solubility limit. Hydrochloric acid concentration also was set at 5% exiting electrolysis or BPED. A per pass recovery of 95% for Li and 100% for other cations in non-selective membranes was used. The other cation recovery was set higher as Li is the major component in these brines and other cations would be recovered to a higher degree as the process continues to reach 95% Li recovery. For the Li selective membranes, the same Li recovery of 95% was used while the other cation recovery was determined based on the selectivity and relative concentrations. The lithium hydroxide and hydrochloric acid solutions were set as evaporated to a 14% solubility limit of LiOH and to 30% HCl, respectively. In sulfate systems, sulfuric acid was set as concentrated to 65%. The vapor from these evaporations would be condensed and returned to the electrolysis or BPED cell as carrier fluid for additional LiOH and HCl/H₂SO₄ being recovered. A steady-state mass balance model incorporating the BPMED separation, evaporation, crystallization of lithium hydroxide monohydrate and filtration was thus developed. Different feed chemistries were run through the model to predict the system at equilibrium state. Particularly, the impurities in the base compartment exit stream were of interest to ensure that Mg and Ca levels remain in solution.

### Example 1, Chilean Evaporation Pond Brine

The performance of a cation selective ED membrane versus a Li selective membrane operating in a BPMED setup on concentrated feed brine is shown in FIG. 5a-FIG. 5c. The feed to BPED is the pond concentrated brine, e.g., natural brine after a degree of solar evaporation (for example, 98% volume). This is a typical Chilean (e.g., Chilean-sourced) concentrated brine composition with a Li/Mg ratio of approximately 10. Additional make-up fresh water is shown added separately to the acid and base compartments to replenish the water exiting with the concentrated acid and base streams, as well as the water of crystallization in LiOH·H₂O. Most of the carrier water is recirculated evaporator crystallizer vapor condensate. Li-depleted effluent from BPMED can be recycled to the evaporation ponds. Comparison of the base compartment exit composition between FIGS. 3a (non-selective membranes) and 3b (selective membranes) shows a marked difference in the impurity levels of the resulting LiOH streams. In reality, Mg concentrations of around 1200 ppm in the base stream, exiting a given conventional ED in FIG. 5a, are not possible, as this concentration exceeds the solubility of Mg in this solution. Mg can be expected to precipitate at these concentrations, making the use of conventional ED membranes impossible. Maximum Mg and Ca levels in this stream need to be less than 3 ppm and 5 ppm respectively to stay in solution, as is achievable with the Li selective membranes. With a Li selective membrane, the impurity profile of the LiOH stream makes it amenable to direct crystallization to a commercially saleable lithium product as seen in FIG. 5b.

FIG. 6c shows application of BPMED using cation exchange membranes (which are not selective between different types of cations) to the process stream after the concentrated feed brine has been treated with a lime-soda softening and/or another hardness-reduction step to precipitate multivalent cations so as to yield a feed brine within the operating capacity of the present BPMED stack. In an embodiment, the total hardness (e.g., Ca+Mg) may be over 10 ppm up to 10,000 ppm (e.g., 1,000 ppm to 10,000 ppm). The LiOH concentrated stream in this case shows low levels of Mg and Ca, but high K and an elevated Na content. Production of lithium hydroxide from this stream may optionally include LiOH recrystallization and IX polishing in addition to the upfront lime-soda softening and/or other hardness-reduction step. This still provides a considerable improvement over the conventional production process because lithium carbonate production is bypassed, and the process steps needed to yield a desired lithium-based output are significantly reduced. The purity of lithium hydroxide monohydrate achieved in cases a, b and c are 95%, 99.9% and 92% respectively.

### Example 2, Argentinian Evaporation Pond Brine

The mass balance summary of treating this brine with BPED is shown in FIGS. 6a-6c. FIG. 6a shows the direct treatment using conventional ED membranes. In this example, the concentrated pond brine (e.g., an Argentinian-sourced brine) is at 1.9% Li with other components as shown in the figure. Non-selective (conventional) ED yields Mg levels in the base compartment of 1662 ppm, which is significantly higher than the less than 3 ppm required to prevent precipitation. Hence, this conventional membrane separation is not preferred in comparison to the systems and methods taught herein using suitable Li or monovalent selective ED membranes for direct LiOH production.

FIG. 6b shows treatment using lithium selective cation exchange membranes. Mg and Ca levels in the base compartment are below the 3 ppm and 5 ppm maximum levels. Notably, Na and K levels are also low, resulting in a high purity LiOH·H₂O product. FIG. 6c shows treatment of brine using a monovalent cation selective ED membrane after subjecting the brine to a lime soda softening process for divalent and multivalent cation removal. In this case, the Mg and Ca levels in the base compartment are at an acceptable level. So, the process is possible; however, due to the high Na and K levels in the base compartment, a relatively crude (˜71% LiOH·H₂O) product is produced with a 60% lower Li current efficiency.

### Example 3, Hardrock (Spodumene) Acid Roasting Leach Liquor

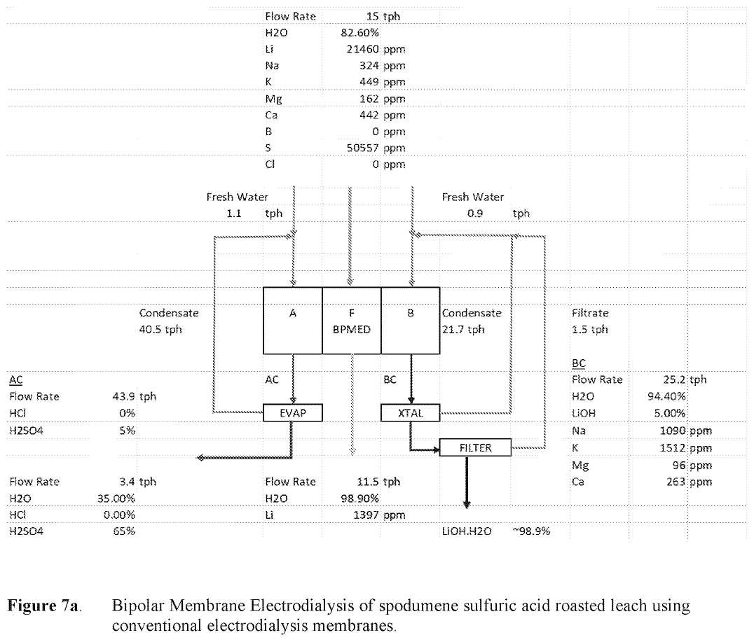

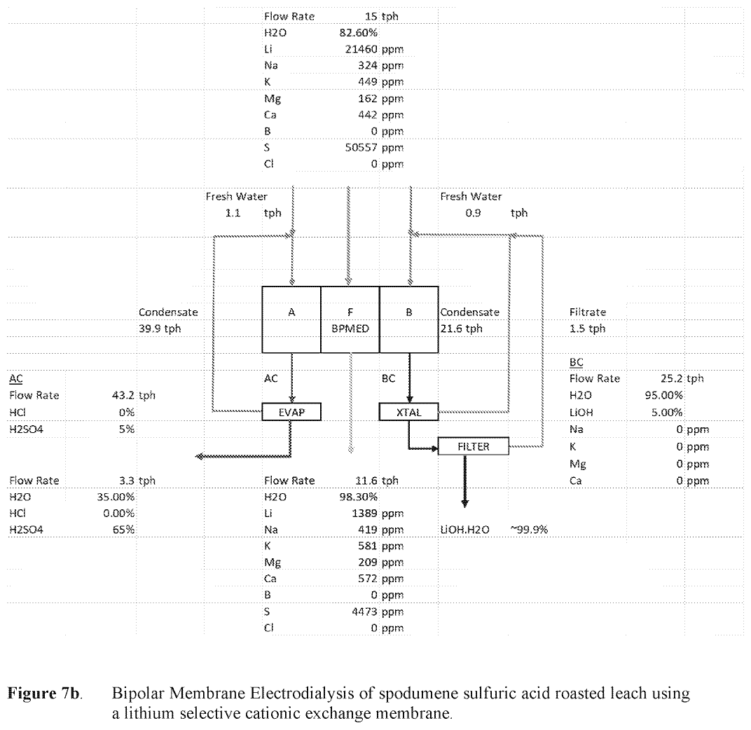

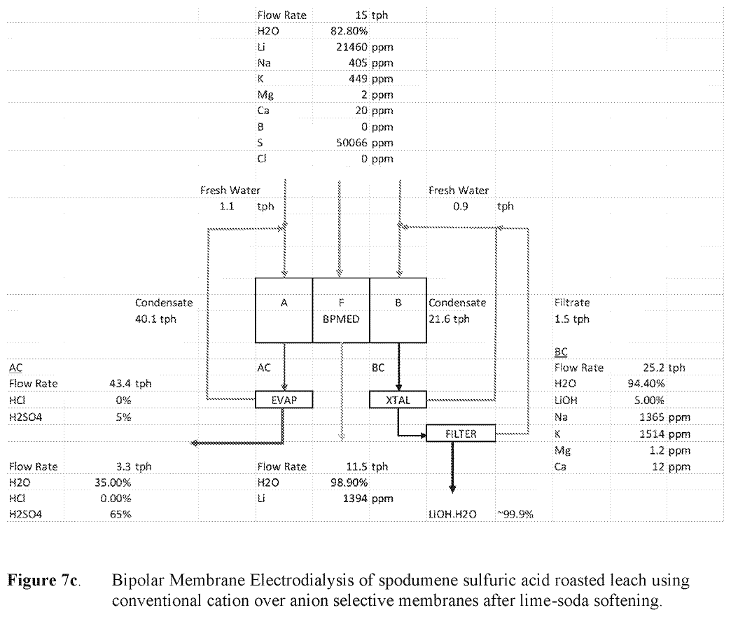

The mass balance summary of treating this material using BPED is shown in FIGS. 7a-7c. The acid roasted leach composition, as shown, was obtained from Bourassa, 2019. FIG. 7a shows the direct treatment using a cation selective conventional ED membrane in BPED. Concentrated leach liquor is at 2.1% Li with other components as shown in the figure. This is a typical sulfate system. Cation selective conventional ED yields Mg levels in the base compartment of 96 ppm and Ca of 263 ppm, which are generally impractical (FIG. 7a). FIG. 7b illustrates an example embodiment of a process employing a lithium selective cation exchange membrane in BPED/BPMED of spodumene sulfuric acid roasted leach using a lithium selective cationic exchange membrane. As shown in FIG. 7c, after the leach liquor is softened, Ca and Mg levels are reduced to 2 and 20 ppm, respectively. The base compartment solution is now at an acceptable Mg concentration of 1.2 ppm. However, the Ca concentration at 12 ppm make this application generally impractical for most purposes. However, by using Li selective membranes (per the present disclosure), a very clean LiOH·H₂O product is possible (FIG. 7b), even without the need for hardness reduction or softening.

In addition to the above, additional examples for typical Bolivian brine (e.g., Bolivian-sourced brine) and other Chilean brines are provided in Table 1. It can be seen that the application of Li-selective cationic exchange membranes in electrolysis or BPED is beneficial in all cases. Lithium selective cation exchange membranes in electrolysis or bipolar electrodialysis on brines evaporated by solar or DLE means or concentrated feed can unlock the pathway to direct lithium hydroxide production from feed brines, direct lithium extraction, and mineral leachates. In specific situations (with the exception of hard rock spodumene) softening of the feed brine is optional before application of conventional noncationic selective ED. The product in such cases, however, may be relatively crude, e.g., contaminated with hydroxides of Na and K which can then require additional purification. Lower lithium current efficiency can also result from recovery of impurity hydroxides.

Li-selective cationic exchange membranes in electrolysis or BPED provide an efficient pathway to direct LiOH production in all major lithium sources such as South American brines and spodumene which account for nearly all the lithium supply today. The systems and methods taught herein also are applicable to other sources of lithium such as hectorite clays, jadarite, zinnwaldite, recycled batteries, non-South-American brines, etc. The methods significantly simplify the processes, which will result in reduced capital, operating and reagent costs, and lower production costs. Other advantages include the ability to process significantly less concentrated feed and obtain higher lithium recovery, because losses with precipitates are avoided both in the ponds and the processing plant.

In Table 1, concentrated LiOH (5%) solution impurity profiles for various realistic brine and hard-rock sources treated using the methodology are disclosed. BPMED used with Li-selective membranes was shown to yield best products. BPMED used on softened feed with cation over anion selective membranes was shown to yield a feasible process in most cases but with less pure products. Liquors treated were either concentrated Li brines from evaporation ponds or leach liquors from spodumene roasting and leaching. In some cases, feed liquors also included those after initial lime-soda softening for removal of multivalent cations.

TABLE 1

| | | | Impurity Concentration Profile (ppm) | | | |
|---|---|---|---|---|---|---|
| Source | Location | ED Type | Mg | Ca | Na | K |
| Chile I | Feed | Cation selective* | 1236* | 184* | 200 | 5239 |
| | Feed | Li-Selective | 1.1 | 0 | 0 | 7 |
| | Softened | Cation selective⁺ | 1.2 | 4.6 | 2563 | 919 |
| Chile II | Feed | Cation selective* | 739* | 0 | 840 | 1108 |
| | Feed | Li-Selective | 0.34 | 0 | 0.87 | 1.5 |
| | Softened | Cation selective⁺ | 0.74 | 0 | 1484 | 1108 |
| Bolivia | Feed | Cation selective* | 406* | 0 | 3 | 2 |
| | Feed | Li-Selective | 0.1 | 0 | 0 | 0 |
| | Softened | Cation selective⁺ | 0.4 | 0 | 643 | 2 |
| Argentina | Feed | Cation selective* | 1662* | 0 | 7287 | 6589 |
| | Feed | Li-Selective | 2.3 | 0 | 425 | 412 |
| | Softened | Cation selective⁺ | 1.6 | 0 | 10062 | 6576 |
| HardRock | Feed | Cation selective* | 96* | 263* | 1090 | 1512 |
| | Feed | Li-Selective | 0 | 0 | 0 | 0 |
| | Softened | Cation selective* | 1.2 | 12* | 1365 | 1514 |

*Precipitation making process infeasible.
⁺Feasible but less desirable due to higher impurities in product necessitating reprocessing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A lithium-generating system, comprising:
a source of a carbon dioxide containing gas;
a lithium-containing source feed for providing a lithium-containing material, the lithium-containing material having a hardness in excess of 10 parts per million (ppm), the hardness defined by a total weight of calcium (Ca²⁺) and magnesium (Mg²⁺) ions present in the source feed;
a bipolar electrodialysis or electrolysis unit for receiving and processing the lithium-containing material, a given bipolar electrodialysis unit including at least one bipolar membrane, a selective cation exchange membrane, and an anion exchange membrane, a given electrolysis unit including a cathode, a selective cation exchange membrane, an anion exchange membrane, and an anode, a given electrolysis unit or a given bipolar electrodialysis unit each configured to generate an aqueous lithium hydroxide product including lithium hydroxide; and
a first reaction site configured to receive the carbon dioxide containing gas and at least a first portion of the aqueous lithium hydroxide product, the first reaction site configured to facilitate a first reaction between an amount of carbon dioxide and the lithium hydroxide of the first portion of the aqueous lithium hydroxide product, the first reaction configured to yield an amount of lithium carbonate.

2. The lithium-generating system of claim 1, wherein the source of a carbon dioxide containing gas is at least one of a direct air capture source or a flue gas source.

3. The lithium-generating system of claim 1, further comprising a carbon dioxide capture unit configured to receive a first carbon dioxide containing gas and to output a release gas, the release gas including a second concentration of carbon dioxide greater than the first concentration of carbon dioxide, the second concentration of carbon dioxide configured to be achieved by a carbon capture process, the first reaction site configured to use the release gas from the carbon dioxide capture unit as the source of the carbon dioxide containing gas at the first reaction site.

4. The lithium-generating system of claim 3, wherein the source of a carbon dioxide containing gas includes the release gas produced by the direct air capture unit, the first carbon dioxide containing gas including less than 0.05% by volume of carbon dioxide, the carbon dioxide capture unit configured to capture the carbon dioxide in the first carbon dioxide containing gas and to thereby output a given release gas with at least 2% by volume of carbon dioxide.

5. The lithium-generating system of claim 4, wherein the carbon dioxide capture unit is configured to output a given release gas with at least 30% by volume of carbon dioxide.

6. The lithium-generating system of claim 1, wherein the first reaction site is configured to generate an amount of battery-grade lithium carbonate.

7. The lithium-generating system of claim 1, wherein the first reaction site is configured to the carbon dioxide containing gas through the at least a first portion of the aqueous lithium hydroxide product at room temperature.

8. The lithium-generating system of claim 1, further comprising a hardness reduction unit configured to receive the lithium-containing material and to reduce the hardness thereof yet still be over 10 ppm, the hardness reduction unit including at least one of a water softening unit, a preliminary electrodialysis unit, a solvent extraction unit, or a resin-based adsorbent unit, the hardness reduction unit configured to yield a hardness-reduced lithium-containing material relative to an initial hardness of the lithium-containing material from the source feed, the hardness reduction unit configured to produce a hardness level within a given hardness-reduced lithium-containing material to be within an operational limit of the at least one bipolar membrane, the hardness-reduced lithium-containing material received by the bipolar electrodialysis or electrolysis unit.

9. The lithium-generating system of claim 1, wherein the lithium-containing source feed comprises a brine feed.

10. The lithium-generating system of claim 1, further comprising a second reaction site configured to receive a second portion of the aqueous lithium hydroxide product, the second reaction site configured to facilitate evaporative crystallization of the lithium hydroxide of the second portion of the aqueous lithium hydroxide product, the second reaction site configured to yield an amount of lithium hydroxide monohydrate.

11. The lithium-generating system of claim 8, wherein the second reaction site is further configured to wash and thereby purify the lithium hydroxide monohydrate.

12. The lithium-generating system of claim 9, wherein the second reaction site is further configured to wash the lithium hydroxide monohydrate with CO₂-free deionized water under a cold CO₂-free environment.

13. A lithium-generating system, comprising:
a lithium-containing source feed including a lithium-containing material, the lithium-containing material having a hardness in excess of 10 parts per million (ppm), the hardness defined by a total number of calcium (Ca²⁺) and magnesium (Mg²⁺) ions present in the source feed;
a hardness reduction unit configured to receive the lithium-containing material and to reduce the hardness thereof yet still be over 10 ppm upon processing by the hardness reduction unit, the hardness reduction unit including at least one of a water softening unit, a preliminary electrodialysis unit, a solvent extraction unit, or a resin-based adsorbent unit, the hardness reduction unit configured to yield a hardness-reduced lithium-containing material; and
a bipolar electrodialysis or electrolysis unit configured for receiving and processing the hardness-reduced lithium-containing material, the bipolar electrodialysis unit including at least one bipolar membrane, the bipolar electrodialysis unit configured to generate an aqueous lithium hydroxide product including lithium hydroxide, the hardness reduction unit configured to produce a hardness level within a given hardness-reduced lithium-containing material to be within an upper operational limit of the at least one bipolar membrane, in addition to being at a given hardness level of over 10 ppm.

14. The lithium-generating system of claim 13, wherein the hardness reduction unit is configured to reduce the hardness below upper operational limit of the at least one cation exchange membrane.

15. The lithium-generating system of claim 13, wherein the hardness reduction unit is configured to achieve a hardness in a range of 500 ppm to 10,000 ppm.

16. The lithium-generating system of claim 13, wherein the lithium-containing source feed includes a lithium-containing material, the lithium-containing material defines at least one of a ratio of Li/Mg ions greater than about 3, a ratio of Li/Ca ions greater than about 5, a ratio of Li/Na ions greater than about 1.5, or a ratio of Li/K ions greater than about 1.5.

17. The lithium-generating system of claim 13, further comprising a source of carbon dioxide containing gas; and a first reaction site configured to receive the carbon dioxide containing gas and at least a first portion of the aqueous lithium hydroxide product, the first reaction site configured to facilitate a first reaction between the carbon dioxide included in the carbon dioxide containing gas and the lithium hydroxide of the first portion of the aqueous lithium hydroxide product, the first reaction configured to yield an amount of lithium carbonate.

18. The lithium-generating system of claim 13, wherein the source of a carbon dioxide containing gas is at least one of a direct air capture source or a flue gas source.

19. The lithium-generating system of claim 13, further comprising an evaporative reaction site configured to receive a portion of the aqueous lithium hydroxide product, the evaporative reaction site configured to facilitate evaporative crystallization of the lithium hydroxide of the second portion of the aqueous lithium hydroxide product, the evaporative reaction site configured to yield an amount of lithium hydroxide monohydrate.
